(19) United States
(12) Patent Application Publication
(10) Pub. No.: US 2025/0031770 A1
(43) Pub. Date: Jan. 30, 2025

(54) MANUFACTURE OF AEROSOL GENERATION DEVICE HOUSING

(71) Applicant: NICOVENTURES TRADING LIMITED, London (GB)

(72) Inventors: Mark ZHANG, London (GB); Robert WHIFFEN, London (GB); Davison DAI, London (GB)

(21) Appl. No.: 18/715,182

(22) PCT Filed: Dec. 1, 2022
(86) PCT No.: PCT/EP2022/084140

§ 371 Date: May 31, 2024

(30) Foreign Application Priority Data
Dec. 1, 2021 (CN) 2021114555301
Jan. 7, 2022 (GB) 2200191.1

(51) Int. Cl. A24F 40/70; B29C 45/37

(52) U.S. Cl. CPC A24F 40/70; B29C 45/372

(57) ABSTRACT

A method of manufacturing a housing component for an aerosol generation device includes injection molding a housing component between first and second die parts. The first die part has a concave surface so as to form a convex surface on the component during the molding, the concave surface of the die having a first texture which imparts a corresponding texture on the convex surface of the component during molding, wherein the first texture includes a variable roughness across the concave surface of the first die part. Also provided are housing components for an aerosol generation device, the housing components having convex surfaces with textures.

### RELATED APPLICATIONS

The present application is a National Phase entry of PCT Application No. PCT/EP2022/084140 filed Dec. 1, 2022, which claims priority to CN Application No. 2021114555301 filed Dec. 1, 2021 and GB Application No. 2200191.1 filed Jan. 7, 2022, each of which is hereby incorporated by reference in their entirety.

### TECHNICAL FIELD

The disclosure relates to aerosol generation devices, to aspects of the housing for such devices, and more particularly to a housing for a Tobacco Heated Product (THP) device.

### BACKGROUND

Smoking articles such as cigarettes, cigars and the like burn tobacco during use to create tobacco smoke. Attempts have been made to provide alternatives to these articles that burn tobacco by creating products that release compounds without burning. Examples of such products are heating devices which release compounds by heating, but not burning, the material. The material may be for example tobacco or other non-tobacco products, which may or may not contain nicotine.

These heating devices may include a housing which holds internal components is held by the user.

### SUMMARY

An aerosol generating device may be provided with a housing which contains some or all of the components for generating an aerosol from a received consumable. Parts of the device housing are held by the user while the device is carried, or when it is used to generate an aerosol. The particular form of the housing can therefore affect or improve the usability of the device.

The housing of the device is used to accommodate the components and functionality which generate the aerosol, and isolate some components internally from the user. The shape and size of the housing can therefore also be influenced by the underlying functionality of the device. For example, a device which generates aerosol by heating of a tobacco product in a heat-not-burn arrangement could be provided with a housing which accommodates a power source, a circuit and a form of heating zone. In devices such as a THP device, there may be a large number of components to be accommodated and isolated from the user.

For example, the usability of the device can be improved by providing the housing with a shape which generally conforms to being gripped by a user's hand. The housing may be provided with surfaces which are flat or given a certain curvature so as to be easily held or gripped in a hand.

The form of the housing, including the shape and size of the housing, may therefore be influenced by both the usability of the device and the accommodation of the aerosol generating functionality. As such, particular housing forms and shapes can be particularly desirable or advantageous to one or more particular types of aerosol generator. In particular, a combination of planar and convex outer surfaces may be particularly easy to grip during use of the device, while providing space for accommodating particular components.

The housing may be provided with features which provide an improved ‘user feel’ to the device by improving the tactile feedback to the user. For example, the use of a particular material in parts of the housing can impart a touch sensation or tactile feedback which a user may associate with a device of high quality or robustness, or a tactile feedback which the user finds enjoyable or comforting.

The tactile feedback can, in particular, be affected by a surface texture of parts of the housing. For example, a surface which has a texture with a relatively high roughness can impart the feeling of an device which is easy to grip, and can provide a reassuring tactile feedback. In another example, a surface which is relatively smooth (i.e. has a relatively low roughness) can impart a touch sensation of solidity, giving the impression of a high-quality or robust device.

It can be desirable to provide a housing which has different touch sensations at different locations to impart an overall impression and a varied tactile feedback to the user. A housing may be provided with a plurality of surfaces having different textures, for example having textures with different roughness to one another. In one example, a surface with a relatively high roughness could be provided at a location of the housing which is intended to be gripped or held by the user, and a surface with a relatively low roughness could be used at a location surrounding a user interface means, such as a button.

It may therefore be advantageous to provide an aerosol generating device, a housing for an aerosol generating device, or components of such a housing, which are formed for usability, which accommodate an aerosol generating functionality, and which provide an improved impression on the user.

More particularly, it may be desirable to provide these advantages in the context of a Tobacco Heated Product (THP) device, which may have a relatively large number of internal components to be isolated from the user, and therefore comprise some elements of size, shape and external form which are particular to that type of device.

Accordingly, there may be provided an aerosol generation device housing comprising a portion which is relatively textured compared to other portions of the housing. This portion may comprise a side panel with a generally curved, convex shape, which conforms to the user grip. This section of the housing may be particularly influential on the overall user impression, because the convex outer surfaces are those most commonly held or gripped by the user during use of the device.

Aerosol generation devices may be produced at a high production volume, requiring a large number of device housings to be created reliably and consistently, at a relatively low cost. Injection molding may be used to create housings or parts of housings for aerosol generation devices. Injection molding may generally comprise preparing a material in liquid, molten form, and introducing the material into a cavity of a die. The cavity comprises a negative shape to the desired component shape. The material in the cavity is cooled and hardened, and then the die is separated to allow the component to be removed. The die may be in two or more halves or sections, to be separated without damaging the die, so it may be re-used.

The textured, convex side-panel portion of the aerosol generation device housing may be formed by injection molding in a die which comprises one half having a textured die surface forming part of the die cavity. The textured die surface imparts a corresponding, negative texture onto the material during cooling, and onto the cooled component. The die halves may be re-used, and the method is relatively cheap, effective and consistent.

With the particular convex shape of the side-panel component, however, issues may arise on separation of the die halves and/or removal of the component therefrom. Due to the shape of the component, the molded textured surface may become locked into the textured die surface and into one half of the die. The component may be difficult to remove from the die half without damaging the component or the die.

In order to avoid die-half locking while still producing components which provide an improved impression on the user of the aerosol generation device, the component may be manufactured with particular features of the surfaces which aid the removal of the component from the die-half without compromising the textured impression of the surface of the aerosol generation device.

The terms “textured” or “rough”, as used herein for comparative purposes between surfaces, may be taken to mean comparatively higher values of surface roughness according to the scale of VDI surface finish, which is commonly used in the art.

According to a first aspect of the disclosure, there is a method of manufacturing a housing component for an aerosol generation device, the method comprising injection molding a housing component between first and second die parts, the first die part having a concave surface so as to form a convex surface on the component during the molding, the concave surface of the die having a first texture which imparts a corresponding texture on the convex surface of the component during molding, wherein the first texture comprises a variable roughness across the concave surface of the first die part.

In a further embodiment, the first texture has a variable roughness such that the roughness is greater in a region at a center of the concave surface than in a region away from the center of the concave surface.

In a further embodiment of any of the foregoing embodiments, the second die part comprises a surface having a second texture, and the second texture has a roughness which is different to a roughness at any location on the concave surface of the first die part.

According to a further aspect of the disclosure, there is a method of manufacturing a housing component for an aerosol generation device, the method comprising injection molding a housing component between first and second die parts, the first die part having a concave surface so as to form a convex surface on the component during molding, the concave surface of the die having a first texture which imparts a corresponding texture on the convex surface of the component during molding, wherein the second die part comprises a surface having a second texture, and the second texture has a roughness which is different to a roughness of the first texture.

In a further embodiment, the second texture has a roughness that is greater than a roughness of the first texture.

In a further embodiment of any of the foregoing embodiments, the concave surface of the first die part comprises a coating, the coating comprising a friction reducing material.

In a further embodiment of any of the foregoing embodiments, the method further comprises the step of forming one or more protruding features onto the concave surface of the housing component during injection molding.

In a further embodiment of any of the foregoing embodiments, the concave surface of the first die part defines a center of curvature, and the concave surface extends at least 160 degrees around the center of curvature.

In a further embodiment of any of the foregoing embodiments, the method further comprises the step of painting, printing, etching or depositing material on the convex surface of the housing component subsequent to the step of injection molding.

According to a further aspect of the disclosure, there is a housing component for an aerosol generation device, the housing component comprising a first, convex surface with a first texture, the first texture having a variable roughness across the convex surface.

In a further embodiment, the first texture comprises a variable roughness such that the roughness is greater in a region at a center of the convex surface than in a region away from the center of the convex surface.

In a further embodiment of any of the foregoing embodiments, the housing component further comprises a second surface with a second texture, wherein the second texture has a roughness which is different to a roughness at any location on the first, convex surface.

According to a further aspect of the disclosure, there is a housing component for an aerosol generation device, the housing component comprising: a first, convex surface with a first texture; and a second surface with a second texture, wherein the first texture and the second texture are different.

In a further embodiment, the second texture has a roughness that is greater than a roughness of the first texture.

In a further embodiment of any of the foregoing embodiments, the first, convex surface and first texture are formed by injection molding.

Although the different examples are described, embodiments of this disclosure are not limited to those particular combinations. It is possible to use some of the components or features from one of the examples in combination with features or components from another one of the examples.

### BRIEF DESCRIPTION OF THE DRAWINGS

Some embodiments of the disclosure will now be described by way of example only and with reference to the accompanying drawings in which:

FIG. 1 shows an aerosol generation device.

FIG. 2 shows a device housing and housing component of the device of FIG. 1.

FIG. 3 shows the housing component of FIG. 2 in isolation.

FIG. 4 shows a sectional view of the device housing along section A-A of FIG. 3.

FIG. 5 shows the housing component of FIG. 3 in an injection mold die.

FIGS. 6a, 6b, and 6c show the injection mold die of FIG. 5 forming the housing component.

FIG. 6 shows a view facing the inside of the removable housing component of FIG. 3.

FIG. 7 shows a further example housing component.

FIG. 8 shows a further example housing component.

FIG. 9 shows a further example housing component.

FIG. 10 shows an example die section for forming the housing component of FIG. 7.

FIG. 11 shows an example die section for forming the housing component of FIG. 8.

FIG. 12 shows an example die section for forming the housing component of FIG. 9.

### DETAILED DESCRIPTION OF THE DRAWINGS

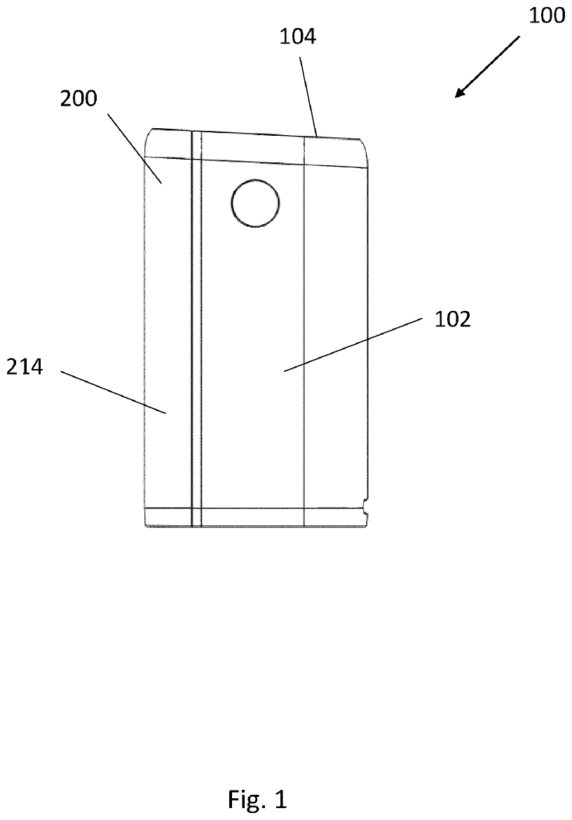

FIG. 1 shows an aerosol generation device 100 and a textured, molded housing component 200 which is joined to the device 100.

The example aerosol generation device 100 is a Tobacco Heated Product (THP) device. The device 100 comprises internal components (not shown) including a power source and a heating zone. The internal components may comprise an induction heater to heat the heating zone. The internal components are received within a device housing 102, and the device housing 102 substantially surrounds or encapsulates the internal components so as to contain the internal components within the device 102. The device housing 102 substantially surrounds the internal components in three dimensions, which encapsulates the internal components within.

The device 100 further comprises a receptacle (not shown) for receiving a consumable. In the example shown, the receptacle is formed substantially within the device housing 102. A receptacle opening 104 is formed in the device housing 102 and links the receptacle to an exterior of the device 100.

In use, the user may insert a consumable through the receptacle opening 104 into the receptacle in the device 100. In the example shown, the receptacle is formed so that the inserted consumable is only partially received within the receptacle, and a portion of the consumable remains exterior to the device 100, on an opposed side of the receptacle opening 104.

The heating zone is associated with the receptacle so that the heating zone is configured to heat a consumable which is received in the receptacle. Upon activation of the device 100, the power source provides heating to the heating zone, the heating zone heats the consumable received within the receptacle, and an aerosol is generated from the consumable. In the example shown, the user may inhale the aerosol from the portion of the consumable which is exterior to the device.

In other examples, the aerosol generation device may comprise a device configured to generate aerosol from a liquid precursor material. The liquid precursor material is received at least partially within a similar device housing, and an opening in the housing is provided for the insertion of the material and/or the inhalation of resulting aerosol by the user.

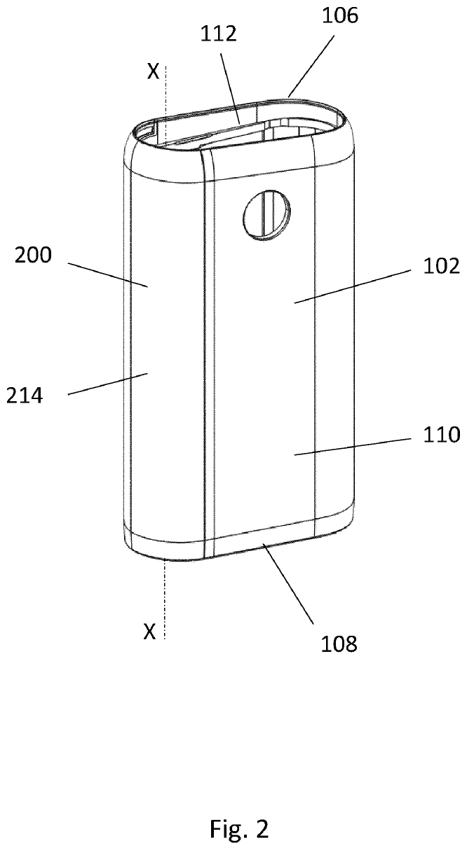

FIG. 2 shows the device housing 102, with the housing component 200 joined thereon. The housing component 200 is joined to the base device housing 102 over a portion of the device housing 102. The device housing 102 is a base housing which receives internal components of the aerosol generation device which are to be isolated from the user, and receives the housing component 200. The housing component 200 covers a portion of the device housing 102. The housing component 200 may therefore be formed separately, to allow imparting of a particular texture onto a surface of the housing component 200, and then joined to the device housing 102.

The device housing 102 defines a device axis X extending through the center of the device 100 in a longitudinal or lengthwise direction. The device housing 102 comprises a first, or proximal, end 106 and a second, or distal, end 108 separated along the axis X in the longitudinal direction. The first end 106 corresponds to the end of the device from which the user may inhale the aerosol which is generated by the device. The receptacle opening of the device is formed at the end of the device corresponding to the first end 106 of the device housing 102. The second end 108 corresponds to the opposed end of the device, generally the end of the device which is furthest from the user when the user inhales aerosol generated from the device.

The device housing 102 comprises a sidewall 110 forming a hollow shell, which extends longitudinally between open ends. A hollow interior of the device housing 102, delimited by the sidewall 110, receives internal components of the device 100, described above. The sidewall 110 extends from the first end 106 of the device 100 to the second end 108. The sidewall 110 extends fully around the axis X. The housing 102 is hollow, and the sidewall 110 of the housing 102 defines an internal space between the first end 106 and the second end 108 into which internal components of the device 100 may be received.

The device housing 102 comprises an outer surface 114, which may be formed to be relatively smooth as compared to a textured surface of the housing component 200. The relatively smooth outer surface 114 may provide an improved impression on the user when used alongside the textured surface of the side panel housing component 200.

The device housing 102 may further comprise first and second endwalls (not shown) which correspond to the first and second ends 106, 108 respectively. The first and second endwalls join to the sidewall 110 to cover or close off the internal space of the device housing 102 at the first and second ends 106, 108 of the device 100. The sidewall 110 and first and second endwalls together form a substantially three-dimensional shell for receiving and encapsulating internal components of the device 100. During assembly of the device, internal components may be placed arranged within the sidewall 110 before one or both of the endwalls are attached to the sidewall 110. This arrangement provides each of manufacture and assembly.

The sidewall 110 is joined or connected to both the first and second endwalls of the housing 102 to form the device housing 102 of the assembled device. The sidewall 110 may be connected to either of the endwalls by being integrally formed therewith. Alternatively, the sidewall 110 may be connected to one or both of the endwalls by a non-removable or permanent attachment means, such as by an adhesive or mechanical interlock.

The terms ‘connected non-removably’ or ‘non-removable’, as used herein, are taken to mean that the connected elements cannot be separated without causing damage to the attachment means, such that the elements could not be reattached by the same attachment means without repair.

In the example shown, the sidewall 110 of the device housing 102 is integrally formed as a single-piece component. In other examples, the sidewall 110 comprises multiple pieces which are joined by a non-removeable attachment means.

The integrally-forming and/or non-removable attachment of the first and second endwalls and sidewall 110 of the device housing 102 prevents or limits the user from disassembling the device housing 102 or accessing the internal components. This may help to avoid the user being exposed to heating or electrical parts within the device 102, or may help to avoid accidental disassembly or breaking of the device 102 by the user.

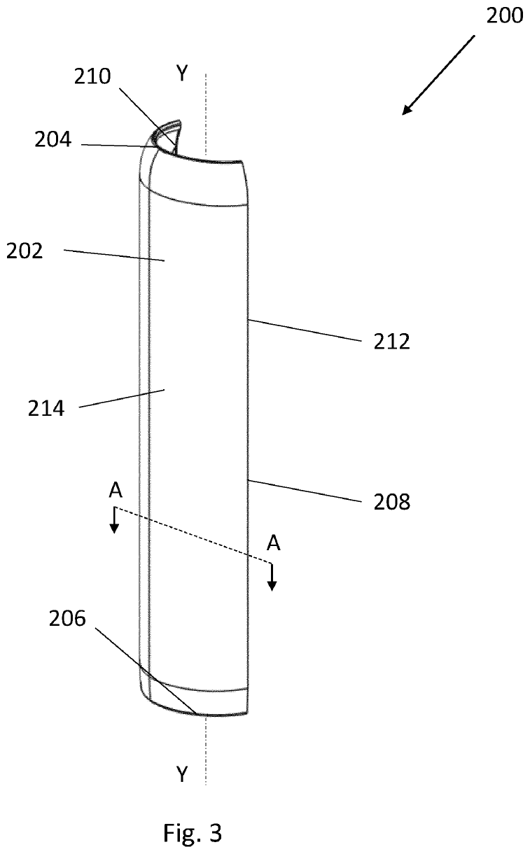

FIG. 3 shows the textured, molded housing component 200 in isolation. The housing component 200 is formed separately to the device housing 102, in order to be more easily formed with a differently textured surface. The housing component 200 may then be joined to the device housing 102.

The housing component 200 comprises a wall 202 having a first end 204 and a second end 206, and extending therebetween to define a longitudinal axis Y of the housing component 200. When the housing component 200 is received on the device 102, the longitudinal axis Y of the housing component 200 is aligned parallel to the longitudinal X of the device 102. The wall 202 further comprises a first edge or side 208 and a second edge or side 210, which each comprise surfaces extending longitudinally between the first end 204 and the second end 206. The wall 202 comprises an inner surface 212 and an opposed, outer surface 214. Each of the inner surface 212 and the outer surface 214 extends longitudinally from the first end 204 to the second end 206, and extends laterally from the first side 208 to the second side 210.

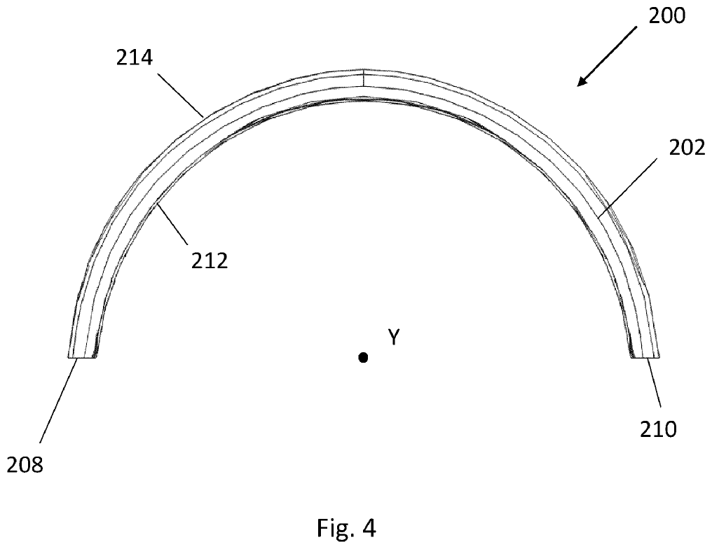

FIG. 4 shows a sectional view of the housing component 200 of FIG. 3, along the line A-A. The outer surface 214 of the wall 202 comprises a generally curved shape so as to conform to the grip of the user. The outer surface 214 is the surface imparted with a texture during an injection molding process.

The outer surface 214 of the wall 202 forms a curved or arced surface. The outer surface 214 comprises a convex shape, defining a curve with an external inflection. The outer surface 214 is convex in the direction along the axis X, so as to form a convex longitudinal profile, or a convex shape when viewed in the direction of the axis X. The outer surface 214 forms a substantially full arc shape, and may comprise a curvature which is generally constant across the substantially full arc shape.

The shape of curve and convexity of the outer surface 214 may be defined in terms of a center of curvature. The outer surface 214 faces away from the center of curvature, defining a convex shape. The outer surface 214 may extend about the center of curvature by approximately 180 degrees, or by between 160 and 200 degrees, so as to form a substantially full arc.

In the depicted embodiment, the inner surface 212 of the wall 202 is also curved or arcuate, to conform to a surface of the device housing 102, so that the housing component 200 may be easily received thereon.

The inner surface 212 comprises a concave shape, defining a curve with an internal inflection. The inner surface 212 is concave in the direction along the axis Y of the housing component 200, so as to form a convex longitudinal profile, or a convex shape when viewed in the direction of the axis Y. The inner surface 212 forms a substantially full arc shape, and may comprise a curvature which is generally constant across the substantially full arc shape.

The shape of curve and concavity of the inner surface 212 may be defined in terms of a center of curvature. The inner surface 212 faces towards the center of curvature, defining a concave shape. The inner surface 212 may extend about the center of curvature by approximately 180 degrees, or by between 160 and 200 degrees, so as to form a substantially full arc.

The housing component 200 may further comprise one or more protruding features (not shown) extending from the inner surface 212. These protruding features may be formed during an injection molding of the housing component 200, along with the rest of the housing component 200 and inner and outer surfaces 212, 214.

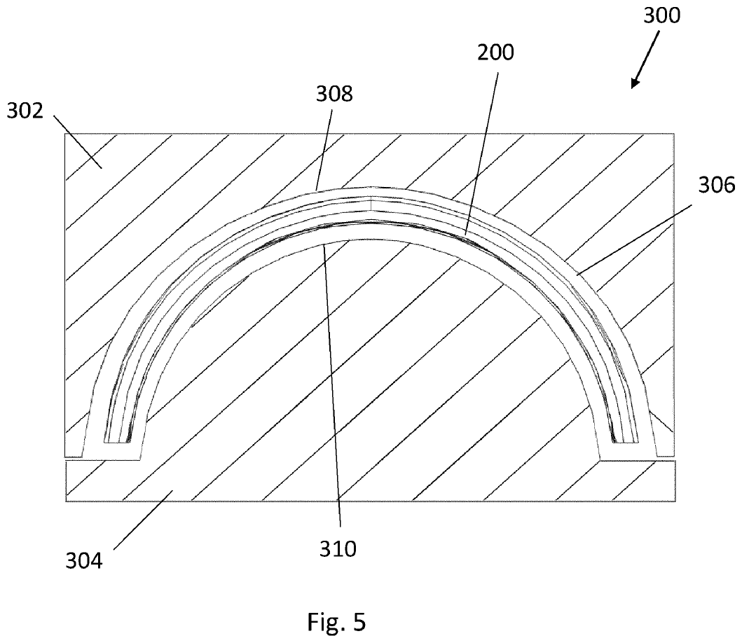

FIG. 5 shows a schematic view of the housing component 200 of FIG. 3 in an injection molding die 300. The injection molding die 300 comprises two die sections or halves 302, 304. In other arrangements, the molding die 300 may comprise more than two sections. The two sections comprise a first, or cavity side, die section 302, and a second, or core side, die section 304.

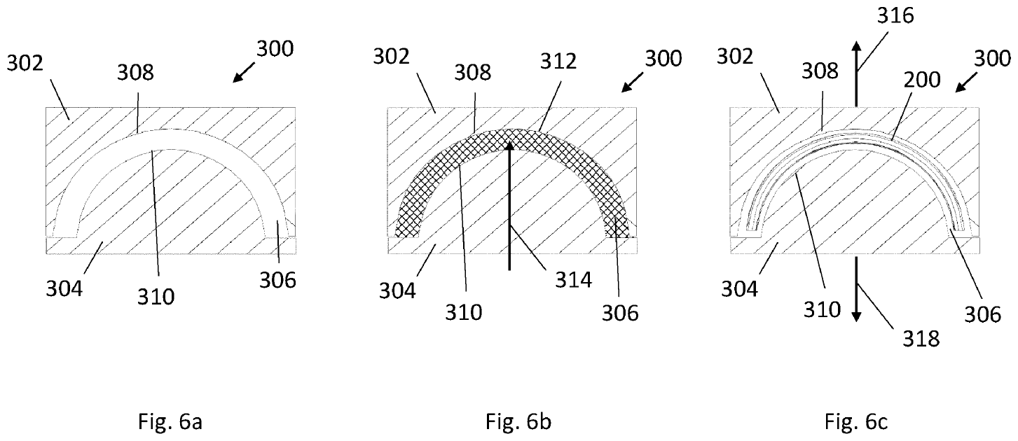

FIGS. 6a to 6c schematically show an example process of injection molding of the housing component 200 with a textured convex outer surface 214.

FIG. 6a shows the cavity die section 302 and the core die section 304 in the closed position, in contact with one another. The die sections 302, 304 in the closed position form a substantially fully enclosed cavity 306 into which liquid material may be introduced and retained to form the housing component 200. The cavity 306 is an empty space forming a negative shape of the intended housing component 200.

The cavity die section 302 and the core die section 304 comprise corresponding first and second cavity surfaces 308, 310. The first and second cavity surfaces 308, 310 define the shape of the cavity 306, and therefore impart a corresponding negative shape of the respective surface 308, 310 onto the housing component 200 during molding. In the embodiment shown, the first cavity surface 308, forming part of the cavity die section 302, comprises a concave shape, which corresponds to a negative of the convex outer surface 214 of the housing component 200. In the embodiment shown, the second cavity surface 310, forming part of the core die section 304, comprises a convex shape, which corresponds to a negative of the concave inner surface 212 of the housing component 200.

The second cavity surface 310 of the core die section 304 may comprise one or more recessions (not shown) into the surface which comprise shapes corresponding to the one or more protruding features to be formed on the concave inner surface 212 of the housing component 200 during the injection molding. The recessions are configured to fill with liquid material during the molding to form the protruding features.

The concave shape of the first cavity surface 308 and the convex shape of the second cavity surface 310 may be defined in a similar manner to those of the outer surface 214 and the inner surface 212 discussed above. For example, one or both of the shapes of the outer surface 214 and the inner surface 212 may define a center of curvature, and extend about the center of curvature by approximately 180 degrees, or by between 160 and 200 degrees, so as to form a substantially full arc.

The first cavity surface 308 comprises a textured surface, so as to impart a corresponding negative texture onto the outer surface 214 of the housing component 200 during molding.

As shown in FIG. 6b, liquid material 312, which may be a heated, molten material, is introduced via a gate shown at arrow 314. The gate 314 comprises a passage through one of the die sections 302, 304 for injecting the material into the otherwise-enclosed cavity 306. The liquid material 312 is prepared outside of the die 300, then forced through the gate 314 and held into the cavity 306 by pressurisation of the liquid material 312. In the embodiment shown, the gate 314 is formed through the core die section 304. The liquid material 312 passes through the gate and substantially fully fills the cavity 306.

As shown in FIG. 6c, after introduction of the liquid material 312, the material is solidified, for example by allowing the molten liquid to cool and harden. The liquid material cools and hardens into the form of the housing component 200. The shape of the housing component 200 on cooling substantially corresponds to the shape of the cavity 306, which in turn is defined by the shape of the first and second cavity surfaces 308, 310.

On removal from the die sections, the housing component 200 may further comprise, in addition to other protruding features of the inner surface 212, a gate sprue (not shown), which is a portion of extraneous material formed by liquid material 312 which remains within the gate 314 during cooling, and which remains attached to the housing component 200. The gate sprue may later be removed, for example by post-molding machining of the housing component 200.

After cooling of the liquid material into the housing component 200, the die sections 302, 304 are separated from one another in order to remove the component 200 from the cavity 306 and from between the die sections 302, 304. The die sections 302, 304 may be separated from one another by moving one or both die sections 302, 304 in a pull direction or directions. In the embodiment shown, the cavity die section 302 is moved in direction 316 relative to the core die section 304, while the core die section 304 is moved in direction 318 relative to the cavity side die section 302. The pull directions 316, 318 may correspond to the directions directly away from the other of the die sections 302, 304, and may be directions each lying in a plane of symmetry of the housing component 200.

After the die sections 302, 304 are separated, the housing component 200 may then be removed from between the cavity surfaces 308, 310, and optionally sent for further processing or machining for finishing. The die sections 302, 304 may then be returned into contact, in the position shown in FIG. 6a, in order to repeat the molding process for a subsequent part.

The material used in injection molding to form the housing component may comprise a thermoplastic. In one example, the material may comprise a polycarbonate thermoplastic resin. In one example, the material may comprise a Lexan® copolymer such as Lexan® Copolymer HFD1810.

The material may be heated to a melt temperature of between 260 and 305 degrees Celsius. The mold may be held in a temperature range of between 50 and 80 degrees Celsius.

A housing component 200 comprising a relatively textured, convex or concave surface (such as outer surface 214) may experience an undesirable binding or locking to a die section. This locking may occur particularly at parts of the cavity surfaces where a curvature of the surface defines a relatively small angle (for example less than 20 degrees) with the pull direction of the opposite die section. This may occur, for example, at the outer surface 214 adjacent to sides 208, 210 of the housing component 200.

The combination of convex curved surface and roughened texture may create portions of material on the component surface which comprise small overhangs relative to one of the pull directions. During pulling of the die sections, this material is prevented from moving relative to the respective cavity surface, locking the component into place. This may also necessitate manual removal of the housing component 200 from the die section 302, which may increase the likelihood of damage.

The convex surface may be damaged by the separating of the die sections, or by manual removal of the component. The surface may be damaged by drag marks, which are areas when texture of the surface is stripped away by the die section surface.

Additionally, where the component comprises protruding features on an opposite surface, such as the inner surface 212, these features may be damaged during pulling of the dies, or if it becomes necessary to manual remove the component.

Returning to the example of FIG. 5, the convex outer surface 214 of the component which is imparted with a relatively rough texture may experience binding to the first cavity surface 308 of the cavity die section 302. The binding may be particularly pronounced in the region of the outer surface 214 which is adjacent to the longitudinal sides 208, 210 of the housing component 200. The binding may cause damage to the outer surface 214 and/or to other parts of the housing component 200 when the die sections 302, 304 are pulled apart, or when the housing component 200 is manually removed from the first cavity surface 308.

A housing component may be provided with further features which allow a convex surface to be formed with a texture which imparts the intended impression on the user and which may be easily formed by injection molding with reduced occurrence of binding or damage.

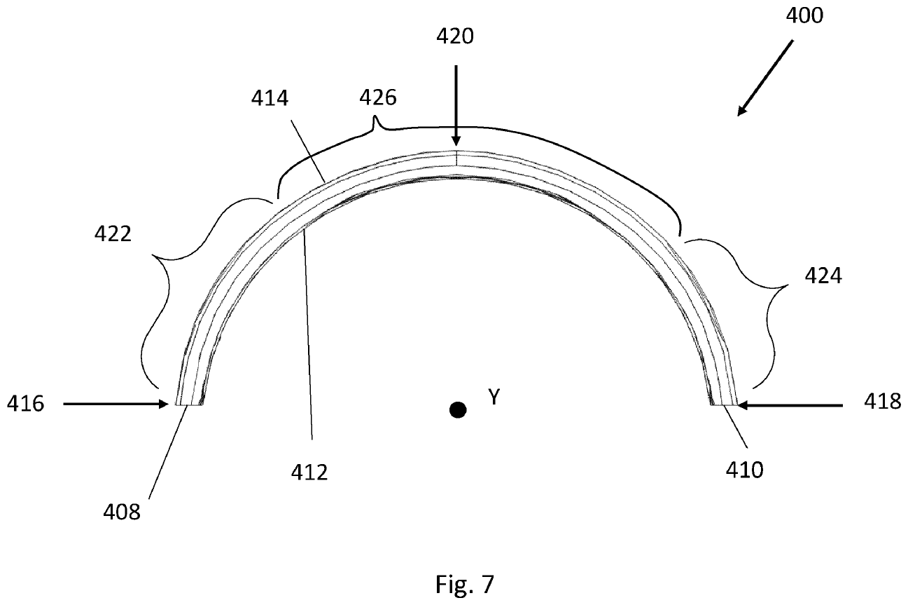

FIG. 7 shows a front view of one example housing component 400. The housing component 400 may comprise the features of the above-described housing component 200. The housing component 400 comprises a convex outer surface 414 extending between first and second sides 408, 410, and the convex outer surface 414 is imparted with a texture by injection molding.

The convex outer surface 414 may comprise a relatively textured surface, or a texture with a relatively rough surface, in order to improve the impression on the user, as discussed above. In particular, the outer surface 414 may comprise a texture with a roughness that, at one location, is different to a roughness of a texture of a concave inner surface 412, which may not be imparted with a texture by the molding or may be imparted with a different texture for purposes other than providing an improved impression (as described further below). The textured surface of the convex outer surface 414 may, at one location, be different to a roughness of a texture of a protruding feature formed on the concave inner surface 412, which may be formed with a relatively smooth texture so as to easily separate from cavities of the mold for forming the protruding feature.

The texture imparted onto the outer surface 414 by the injection molding comprises a variable roughness. That is, the roughness of the outer surface 414 at one location is different to the roughness at another location. As described further below, by comprising an outer surface 414 with a texture which has a variable roughness, the housing component 400 may be more easily manufactured by injection molding, while retaining the convex shape and texture which are advantageous for use in an aerosol generation device.

The roughness of the texture of the outer surface 414 is variable around a curvature of the convex shape of the outer surface 414. The longitudinal profile of the outer surface 414 comprises side locations, shown at 416 and 418, directly adjacent the longitudinal sides 408, 410 of the housing component 400, and a center location, shown at 420, which is halfway across the outer surface 414 between the two sides 408, 410. The outer surface 414 may comprise a texture with a roughness that is greater at the center 420 than at either of the first or second side locations 416, 418.

The outer surface 414 may comprise a texture with a variable roughness by being provided with discrete sections of area having different roughness to one another. The roughness of the textures may be substantially the same across the entirety of each of these areas or portions of the outer surface 414.

In the embodiment shown, the outer surface 414 comprises three such areas or portions. The first and second surface portions 422, 424, which comprise regions of the outer surface 414 which are adjacent to the first and second side locations 418, 420, respectively. The outer surface 414 further comprises a third surface portion 426, which comprises the region of the outer surface 414 between the first and second surface portions 422, 424. The first and second surface portions 422, 424 comprise a texture with a roughness which is different to a roughness of a texture of the third surface portion 426. In one example, the first and second surface portions 422, 424 may comprise a texture with a roughness which is greater than a roughness of a texture of the third surface portion 426. One or more of the first, second and third surface portions 422, 424, 426 may comprise a texture with a surface roughness that is substantially the same across the entire respective surface portion 422, 424, 426.

While an example is shown in which the outer surface 414 is divided into three areas or portions with different roughness, it should be understood that any plurality of areas or portions may be used to provide an outer surface comprising a texture with a variable roughness.

By comprising portions 422, 424, 426 of the outer surface 414 which have textures with different, constant roughness, the outer surface 414 may comprise an overall variable roughness in a form which is relatively simple to manufacture.

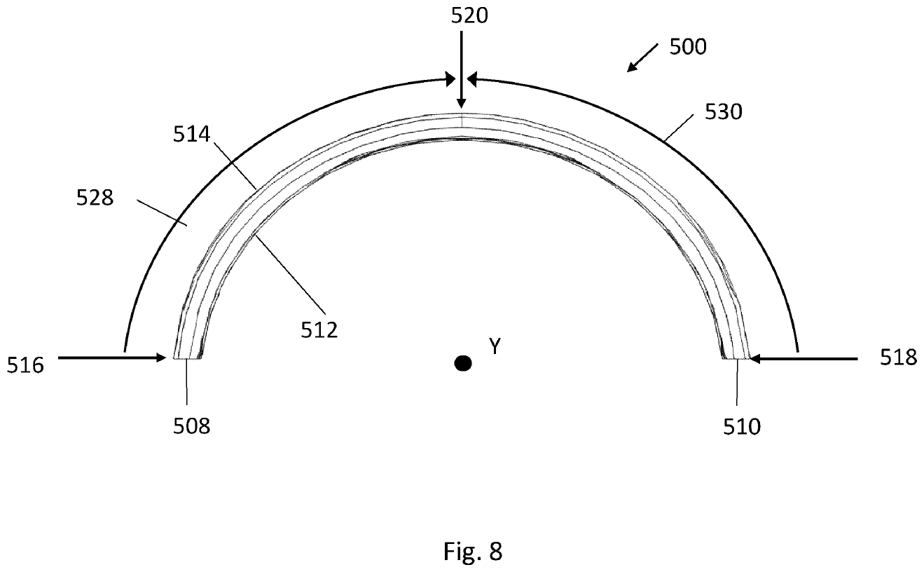

FIG. 8 shows a front view of another example housing component 500. The housing component 500 may comprise the features of the above-described housing component 200. The housing component 500 comprises a convex outer surface 514 extending between first and second sides 508, 510, and the convex outer surface 514 is imparted with a texture by injection molding.

The convex outer surface 514 may comprise a relatively textured surface, or a texture with a relatively rough surface, in order to improve the impression on the user, as discussed above. In particular, the outer surface 514 may comprise a texture with a roughness that, at one location, is different to a roughness of a texture of a concave inner surface 512, which may not be imparted with a texture by the molding or may be imparted with a different texture for purposes other than providing an improved impression (as described further below). The textured surface of the convex outer surface 514 may, at one location, be different to a roughness of a texture of a protruding feature formed on the concave inner surface 512, which may be formed with a relatively smooth texture so as to easily separate from cavities of the mold for forming the protruding feature.

The housing component 500 is similar to the previously-described housing component 400. The texture imparted onto the outer surface 514 by the injection molding comprises a variable roughness. That is, the roughness of the outer surface 514 at one location is different to the roughness at another location. The roughness of the texture of the outer surface 514 is variable around a curvature of the convex shape of the outer surface 514.

The housing component 500 differs from the previously-described housing component 400 in that the outer surface may not comprise discrete portions with textures comprising different degrees of roughness, but may instead comprise a texture with a roughness which varies continuously across a portion of the outer surface 514.

As shown in FIG. 8 at arrows 528 and 530, the outer surface 514 may comprise a texture with a roughness which gradually and substantially continuously varies across the outer surface 514 between a first side 508 and a second side 510.

In the example shown, the longitudinal profile of the outer surface 514 comprises side locations, shown at 516 and 518, directly adjacent the longitudinal sides 508, 510 of the housing component 500, and a center location, shown at 520, which is halfway across the outer surface 514 between the two sides 508, 510. The outer surface 514 comprises a texture with a roughness which increases gradually and continuously between the first side location 516 and the center location 520, as shown by arrow 528. The continuous increase is such that the roughness of the texture of the outer surface 514 is the same or greater at any location closer to the center 520 than the roughness of the texture at another location closer to the first side location 516.

The outer surface 514 may further comprise a texture with a roughness which increases gradually and continuously between the second side location 518 and the center 520 in a similar manner, as shown at arrow 530. The roughness of the texture between the second side location 518 and the center 520 may vary at the same degree or profile as between the first side location 516 and the center 520, such that the outer surface 514 comprises a substantially symmetrical roughness of texture about the center 520.

In the example shown, the texture may comprise a roughness gradient which is substantially constant between two locations, so that the rate of change of roughness of the texture across the outer surface 514 between the locations is consistent. In other examples, a roughness gradient may change between two locations, so that the roughness of texture may vary continuously, but by differing degrees across the outer surface 514 between the two locations.

By comprising a texture with a continuously variable roughness, the outer surface 514 may comprise an overall variable roughness in a form which provides an improved impression to the end user, by avoiding step changes in roughness which might otherwise be appreciable in touch when the user grips the outer surface.

Example housing components are depicted in which the outer surfaces comprise a texture with either discrete portions of different, constant roughness, or a continually variable roughness; however, a housing component may be provided with combinations of the two variable roughness features.

For example, returning to FIG. 7 and the housing component 400, the first and second portions 422, 424 of the outer surface 414 may comprise a texture with a roughness which varies continuously across the respective portion, while the third portion 426 may comprise a roughness which is substantially constant across the portion. In each of the first and second portions 422, 424, the roughness of the texture may gradually increase towards locations in the respective surface portion which are closer to the center 420 of the outer surface 414. The continuous increase is such that the roughness of the texture of the respective portion 422, 424 is the same or greater at any location closer to the center 420 than the roughness of the texture at another location closer to the nearest of the first or second side locations 416, 418.

By comprising portions 422, 424, 426 of the outer surface 414, some of which have textures with different, constant roughness, and some of which have textures with a continuously variable roughness, the outer surface 414 may provide a balance between being simple to manufacture, while providing an improved impression to the end user by avoiding step-changes in roughness which are appreciable in touch.

In any of the above embodiments, the outer surface 414, 514 may comprise a texture with a roughness which does not vary, or is substantially the same, along the longitudinal length of the housing component 400 along axis Y. That is, the outer surface 414, 514 may comprise a roughness which varies in a longitudinal profile, but is consistent along a longitudinal length of the respective housing component 400, 500.

Providing the convex outer surface 414, 514 of the housing component 400, 500 with a variable texture may affect the tendency of the housing component 400, 500 to lock into an injection molding die section, as discussed above in relation to FIGS. 6a to 6c. Providing a surface with increased or decreased texture roughness at some locations as compared to other locations may affect the tendency of the surface to adhere to the die section at that location. This may be applied particularly to a component requiring a highly convex surface in order to reduce the tendency of the component to adhere to a die section at some extremities of the convex shape.

As such, providing a convex surface with a texture having a variable roughness may reduce the occurrence of damage to the component during die pulling or arising from needing to manually remove the component. The texture with variable roughness may also retain the advantage to an aerosol generation device of providing a convex housing component, and the advantage of providing an improved impression to the user by imparting a texture to the held parts of the device housing.

In each of the above embodiments, the outer surface 414, 514 may comprise a texture with a roughness that is greater at the center 420, 520 than at either of the first or second side locations 416, 418, 516, 518 by being provided with a variable roughness. Where the convex surface texture comprises a roughness which is greater towards a center of the surface than towards the sides, the ease of manufacture of the component may be improved, because the relationship between increased texture roughness and tendency to locking is greater at the sides of the convex shape, so the component may be more easily freed from the die section.

In other embodiments, however, other variations in roughness across the convex surface may also be used to improve the ease of manufacture of the housing component. For example, a texture which has a roughness which is the same at the center as at the side locations, but is reduced at other locations across the convex surface, may still result in an improved ease of manufacture if the component requires less force to be removed from the die section.

Alternatively or additionally to any of the above embodiments, the housing component may be provided with features on surfaces other than the convex outer surface which also improve the manufacturability of the housing component 500.

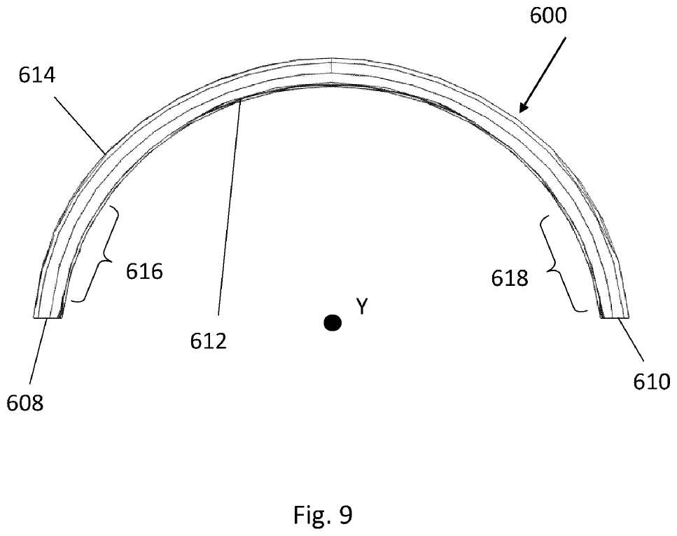

FIG. 9 shows a front view of one example housing component 600. The housing component 600 may comprise the features of the above-described housing component 200. The housing component 600 comprises a convex outer surface 614 extending between first and second sides 608, 610, and the convex outer surface 614 is imparted with a texture by injection molding. The outer surface 614 may comprise a texture with a constant roughness across substantially the whole surface from adjacent the first side 608 to adjacent the second side 610. Alternatively, the convex outer surface 614 may be provided with a variable roughness according to any of the embodiments described above.

The first and second sides 608, 610 comprise longitudinally extending surfaces which extend along the axis Y between first and second ends of the housing component 600.

The component 600 comprises a concave inner surface 612 extending between the first and second sides 608, 610. The concave inner surface 612 may comprise first and second regions 616, 618 of the surface which are adjacent to the first and second sides 608, 610.

The surfaces of the first and second sides 608, 610 and/or all or parts of the concave inner surface 612 may be provided with a texture having a roughness which is different to the roughness of the texture of the convex outer surface 614, in order to improve the removal of the component 600 from a die section.

First and second side surfaces 608, 610 and/or all or parts of the concave inner surface 612 may be textured to increase the adherence to a die section different to the die section forming the convex outer surface 614. As such, during separation of the dies, the convex outer surface 614 and the housing component 600 may more readily remove from the other side die section. The need to manually remove the housing component 600 may also be reduced, which may reduce the occurrence of damage to the component surfaces or protruding features which might occur during manual removal.

The concave inner surface 612 may comprise a texture at the first and second regions 616, 618 which has a roughness different, for example greater than, the roughness of the texture of the convex outer surface 614. The roughness at the first and second regions 616, 618 may be particularly effective for aiding the removal of the component 600 from the die section. The concave inner surface 612 away from the first and second regions 616, 618 may be relatively smooth or non-textured, such that first and second regions 616, 618 comprise textures with roughnesses that are greater than a roughness of a texture of the remaining concave inner surface 612. By comprising a rough texture on only one part of the inner surface 612, the housing component 600 may be more easily removed from the die section as discussed, without being so textured as to become difficult to remove from the other die section.

Alternatively, the concave inner surface 612 may not comprise distinct regions of texture, and may instead comprise a texture across the whole surface which has a roughness different to a roughness of a texture of the convex outer surface 614. The degree of roughness of the entire concave inner surface 612 may instead be varied to aid removal from one die section without locking to another.

Additionally or alternatively to any of the above, the surfaces of each of the first and second sides 608, 610 may comprise a texture with a roughness which is greater than a roughness of the convex outer surface 614. The first and second sides 608, 610 may both comprise textures with roughness which is the same, for ease of manufacture. Alternatively, the first and second sides 608, 610 may comprise textures with roughness which are different on respective sides 608, 610.

The first and second sides 608, 610 may comprise a relatively textured surface, or a texture with a relatively rough surface. The first and second sides 608, 610 may comprise a texture with a roughness that is the same as the roughness of the texture of a concave inner surface 612. Providing textured surfaces at an opposed side of the housing component 600 to the convex surface 614 may improve the adherence to an opposite side die section. The first and second side surface may each face a direction that is substantially opposite to a direction of the convex outer surface 614, which may provide particular improvement in aiding the removal of the component 600.

The position of the concave inner surface 612 and the first and second side surfaces 608, 610 relative to the convex outer surface 614 may be such that the concave inner surface 612 and side surfaces 608, 610 are hidden from the user when the housing component 600 is joined to an aerosol generation device, as described above. As such, the texture of the concave inner surface 612 and first and second side surfaces 608, 610 may not be exposed to the user during user, and may not affect or compromise the impression imparted on the user.

The features of the textured concave inner surface 612 and/or textured first and second side surfaces may be provided in combination with a convex outer surface having a texture with a variable roughness, as described in any of the above embodiments, in order to provide the combined effects of the features and a housing component with improved ease of manufacture.

FIGS. 9, 10 and 11 show die sections configured to form the features of the housing components described above. The die sections comprise cavity surfaces with negative shapes corresponding to the shapes of the above-described features, so as to form the shapes during injection molding. The die sections may be used in the above-described injection molding die 300.

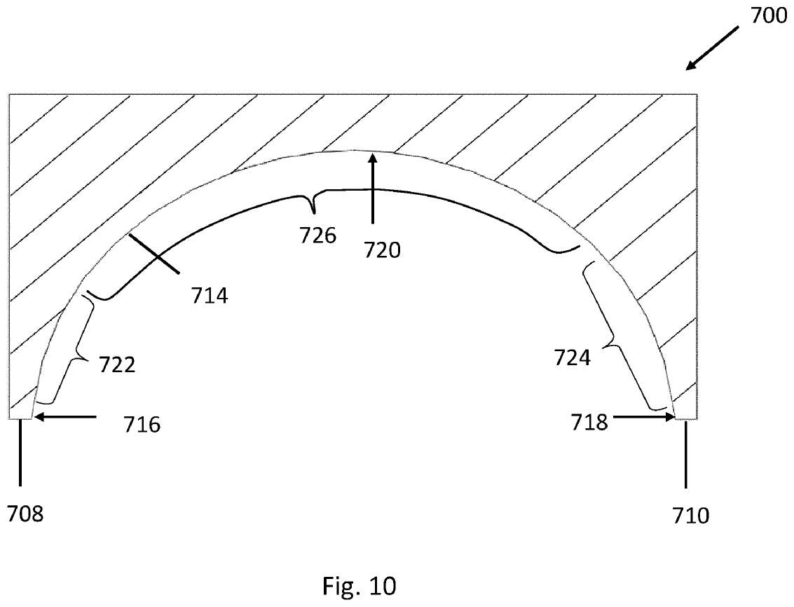

FIG. 10 shows a cavity side die section 700 which may comprise the features of the cavity side die section 302 of the above-described embodiments. The cavity side die section 700 may be used with the core side die section 304 of the above-described injection molding die 300. The cavity side die section 700 is configured to form the housing 400 with a convex outer surface 414 having a texture with a variable roughness.

The cavity side die section comprises a concave cavity surface 714 extending between first and second die sides 708, 710, and the concave cavity surface 714 imparts a texture during injection molding.

The concave cavity surface 714 may comprise a relatively textured surface, or a texture with a relatively rough surface, in order to impart the intended texture onto the housing component 400, as discussed above. In particular, the concave cavity surface 714 may comprise a texture with a roughness that, at one location, is different to a roughness of a texture of a second cavity surface 310 of the corresponding core side die section 304, which is not imparted with a texture for molding.

The second cavity surface 310 may be relatively smooth or non-textured, such that the concave cavity surface 714 comprises a texture with a roughness that is greater than a roughness of a texture of the second cavity surface 310. The second cavity surface 310 may be relatively smooth to improve the ease of manufacture of protruding features of the housing component, if present.

The texture of the concave cavity surface 714 comprises a variable roughness corresponding to the variable roughness of the outer surface 414 of the housing component 400. The roughness of the texture of the cavity surface 714 is variable around a curvature of the concave shape of the cavity surface 714. The longitudinal profile of the cavity surface 714 comprises side locations, shown at 716 and 718, directly adjacent the die sides 708, 710, and a center location, shown at 720, which is halfway across the cavity surface 714 between the two sides 708, 710.

The concave cavity surface 714 comprises first and second surface portions 722, 724, which comprise regions of the cavity surface 714 which are adjacent to the first and second side locations 718, 720, respectively. The cavity surface 714 further comprises a third surface portion 726, which comprises the region of the outer surface 714 between the first and second surface portions 722, 724.

The features of the concave cavity surface 714 correspond to those described in relation to the outer surface 414 of the housing component 400, in that the cavity surface 714 comprises a negative shape configured to impart the texture on the outer surface 414. The locations 716, 718, 720 and first, second and third surface portions 722, 724, 726 of the cavity surface 714 correspond to the locations 416, 418, 420 and first, second and third surface portions 422, 424, 426 of the outer surface 414, and the features of the variable roughness of the texture of the concave cavity surface 714 correspond accordingly.

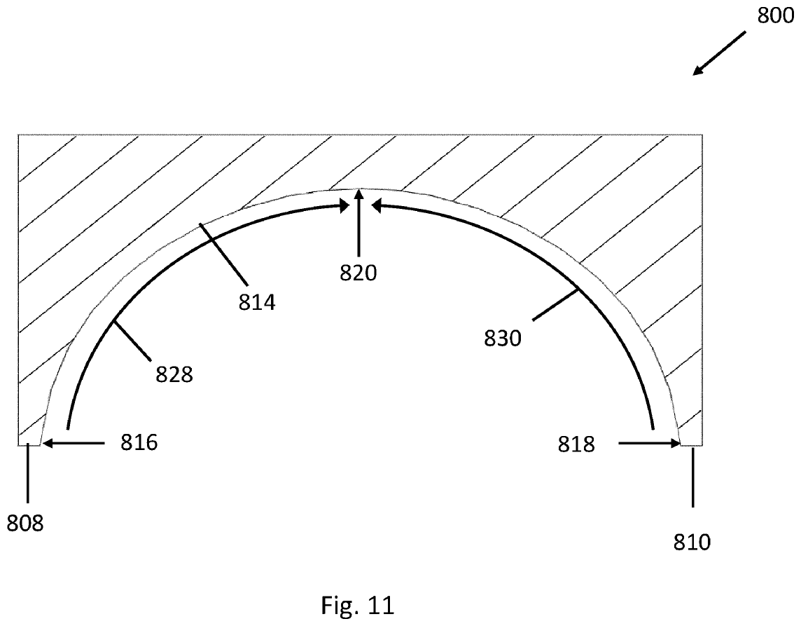

FIG. 11 shows a cavity side die section 800 which may comprise the features of the cavity side die section 302 of the above-described embodiments. The cavity side die section 800 may be used with the core side die section 304 of the above-described injection molding die 300. The cavity side die section 800 is configured to form the housing 500 with a convex outer surface 514 having a texture with a continually variable roughness.

The cavity side die section 800 comprises similar features to cavity side die section 700, including a concave cavity surface 814 comprising similar locations 816, 818, 820 formed between die sides 808, 810. The cavity side die section 800 may similarly be used alongside a core side die section 304 having a second cavity surface 310 which is relatively smooth or non-textured.

The concave cavity surface 814 comprises a texture with a variable roughness corresponding to the variable roughness of the texture of the outer surface 514 of the housing component 500. The roughness of the texture accordingly varies continuously in a similar manner between the locations 816, 818 and 820 as shown by arrows 828 and 830. The features of the variable roughness of the texture of the concave cavity surface 814 correspond accordingly to those of the convex outer surface 514.

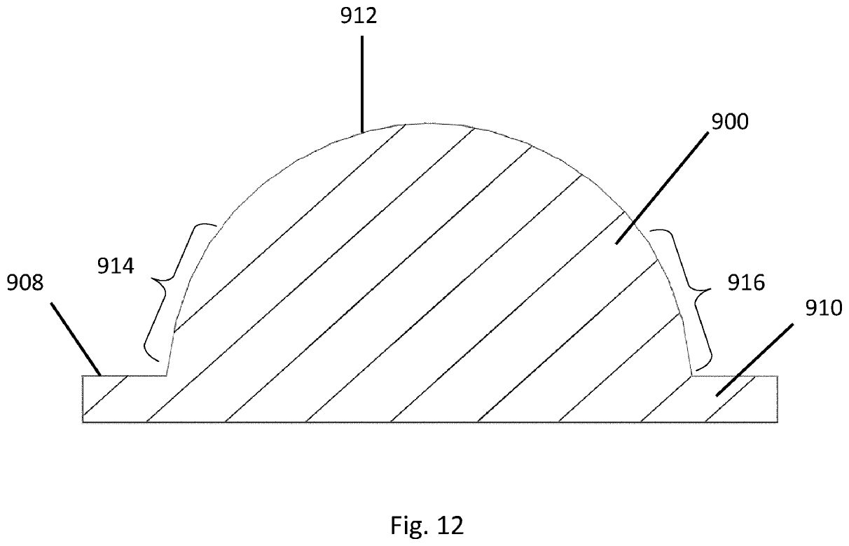

FIG. 12 shows a core side die section 900 which may comprise the features of the core side die section 304 of the above-described embodiments. The core side die section 900 may be used with the cavity side die section 302 of the above-described injection molding die 300. The core side die section 900 is configured to form the housing 600 with concave inner surface 612 and first and second side surfaces 608, 610 having a textures with a roughness.

The core side die section comprises a convex cavity surface 912 and first and second side cavity surfaces 908, 910. The first and second side cavity surfaces 908, 910 may be planar. The first and second side cavity surfaces 908, 910 are textured to form the corresponding texture 608, 610 on the first and second sides 608, 610 of the housing component 600.

The convex cavity surface 912 may comprise first and second regions 914, 916 which are differently textured to areas away from the first and second regions 914, 916, to provide a different texture to parts of the concave inner surface of the housing component, as described above.

The convex cavity surface 912 and the first and second side cavity surfaces 908, 910 may comprise relatively textured surfaces, or a texture with a relatively rough surface, in order to impart the intended texture onto the housing component 600, as discussed above. In particular, the convex cavity surface 912 and the first and second side cavity surfaces 908, 910 may comprise a texture with a roughness that is different to a roughness of a texture of a first, concave cavity surface 308 of the corresponding core side die section 302.

The convex cavity surface 912 and the first and second side surfaces 908, 910 comprise negative shapes configured to form the concave inner surface 612 and the first and second sides 608, 610 of the housing component, and so may comprise any of the features discussed in relation thereto.

The core die section 900 may be used with a cavity die section comprises substantially no texturing or a smooth surface as discussed above, or may be used with a cavity side die section 700, 800 with any of the features of textures with variable roughness discussed above.

Each of the cavity or core die sections 700, 800, 900 discussed above may be imparted with textures comprising difference roughness by using etching, for example laser etching, on the respective cavity surface of the die section.

Any one or all of the cavity surfaces of any of the above-discussed cavity or core die sections may be partially or entirely covered with a friction-reducing coating comprising a friction-reducing material with a lower coefficient of friction than the cavity surface. In one example the coating may comprise Teflon® material. In particular, such a coating may be applied to surfaces comprising a variable roughness, so that housing components may be more easily removed from such surfaces.

Although example embodiments have been described, a person skilled in the art would recognize that certain modifications would come within the scope of this disclosure. For that reason, the following claims should be studied to determine the scope and content of this disclosure.

1. A method of manufacturing a housing component for an aerosol generation device, the method comprising:
injection molding a housing component between first and second die parts, the first die part having a concave surface so as to form a convex surface on the component during the molding, the concave surface of the die having a first texture which imparts a corresponding texture on the convex surface of the component during molding,
wherein the first texture comprises a variable roughness across the concave surface of the first die part.

2. The method of claim 1, wherein the first texture has a variable roughness such that the roughness is greater in a region at a center of the concave surface than in a region away from the center of the concave surface.

3. The method of claim 2, wherein the second die part comprises a surface having a second texture, and the second texture has a roughness which is different to a roughness at any location on the concave surface of the first die part.

4. A method of manufacturing a housing component for an aerosol generation device, the method comprising:
injection molding a housing component between first and second die parts, the first die part having a concave surface so as to form a convex surface on the component during molding, the concave surface of the die having a first texture which imparts a corresponding texture on the convex surface of the component during molding,
wherein the second die part comprises a surface having a second texture, and the second texture has a roughness which is different to a roughness of the first texture.

5. The method of claim 4, wherein the second texture has a roughness that is greater than a roughness of the first texture.

6. The method of claim 4, wherein the concave surface of the first die part comprises a coating, the coating comprising a friction-reducing material.

7. The method of claim 4, further comprising the step of forming one or more protruding features onto the concave surface of the housing component during injection molding.

8. The method of claim 4, wherein the concave surface of the first die part defines a centre of curvature, and the concave surface extends at least 160 degrees around the centre of curvature.

9. The method of claim 4, further comprising the step of painting, printing, etching or depositing material on the convex surface of the housing component subsequent to the step of injection molding.

10. A housing component for an aerosol generation device, the housing component comprising a first, convex surface with a first texture, the first texture having a variable roughness across the convex surface.

11. The housing component of claim 10, wherein the first texture comprises a variable roughness such that the roughness is greater in a region at a center of the convex surface than in a region away from the center of the convex surface.

12. The housing component of claim 11, further comprising a second surface with a second texture, wherein the second texture has a roughness which is different to a roughness at any location on the first, convex surface.

13. (canceled)

14. (canceled)

15. The housing component of claim 10, wherein the first, convex surface and first texture are formed by injection molding.

16. The method of claim 1, wherein the concave surface of the first die part comprises a coating, the coating comprising a friction-reducing material.

17. The method of claim 16, further comprising the step of painting, printing, etching or depositing material on the convex surface of the housing component subsequent to the step of injection molding.

18. The method of claim 1, further comprising the step of forming one or more protruding features onto the concave surface of the housing component during injection molding.

19. The method of claim 1, wherein the concave surface of the first die part defines a center of curvature, and the concave surface extends at least 160 degrees around the center of curvature.

20. The method of claim 1, further comprising the step of painting, printing, etching or depositing material on the convex surface of the housing component subsequent to the step of injection molding.

21. The method of claim 6, further comprising the step of painting, printing, etching or depositing material on the convex surface of the housing component subsequent to the step of injection molding.

22. The housing component of claim 10, further comprising a second surface with a second texture, wherein the second texture has a roughness which is different to a roughness at any location on the first, convex surface.
